(19) United States
(12) Patent Application Publication
(10) Pub. No.: US 2026/0168249 A1
(43) Pub. Date: Jun. 18, 2026

(54) ROOFS AND ROOF ASSEMBLIES INCLUDING POROUS CORES AND CONTINUOUS FIBER SKINS

(71) Applicant: HANWHA AZDEL, INC., Forest, VA (US)

(72) Inventors: Troy Robertz, Warren, MI (US); Joseph Legault, Warren, MI (US); Joseph Dumeah, Warren, MI (US); Arturo Lopez, Elkhart, IN (US)

(21) Appl. No.: 19/332,700

(22) Filed: Sep. 18, 2025

Related U.S. Application Data
(60) Provisional application No. 63/696,178, filed on Sep. 18, 2024.

(51) Int. Cl. E04D 3/35; B60R 13/08

(52) U.S. Cl. CPC E04D 3/351; B60R 13/0815

(57) ABSTRACT

Certain configurations of a multi-layer assembly including two or more porous cores and a continuous skin are described. The multi-layer assemblies can be used in roofs and roof assemblies in vehicles or building applications. The multi-layer assemblies can also be used with a radial end-cap to enhance bonding of the multi-layer assembly to underlying support structures.

### PRIORITY APPLICATION

This application claims priority to, and the benefit of, U.S. Provisional Application No. 63/696,178 filed on Sep. 18, 2024, the entire disclosure of which is hereby incorporated herein by reference for all purposes.

### TECHNOLOGICAL FIELD

Certain embodiments are described in connection with roofs and roof assemblies which include two or more individual porous cores coupled to a first surface of a continuous fiber skin.

### BACKGROUND

Roofs on vehicles including recreational vehicles often leak due to warpage, cracking, rotting, seam opening, sun damage, vibration, stress or other undesired structural or mechanical problems. Repair of the leaking roof can be difficult and often entails using sealing caulk or other temporary materials to seal any openings. These solutions often provide temporary relief of the leaking and frequent leaking reoccurs.

### SUMMARY

Certain aspects of multi-layer assemblies, radial end-caps for use with the multi-layer assemblies and structures including the multi-layer assemblies and radial end-caps are described below.

In an aspect, a roof assembly comprises a multi-layer assembly comprising a plurality of individual porous cores coupled to a continuous multi-ply glass fiber skin at a first surface of the continuous multi-ply glass fiber skin. In certain embodiments, each of the plurality of individual porous cores comprises a web comprising a random arrangement of reinforcing materials held in place by a thermoplastic material. In some embodiments, the continuous multi-ply glass fiber skin comprises at least two individual glass fiber layers each comprising a unidirectional orientation of glass fibers held in place by a binder material. In other embodiments, the plurality of individual porous cores are coupled to the continuous multi-ply glass fiber skin to position the continuous multi-ply glass fiber skin on an exterior surface of the roof assembly.

In certain embodiments, an adhesive layer can be present between the individual porous cores and the continuous multi-ply glass fiber skin. For example, the adhesive layer comprises one or more of polyurethane, a polyolefin or a polyamide.

In other embodiments, an anti-slip material coupled to a second surface of the continuous multi-ply glass fiber skin.

In certain embodiments, at least two individual glass fiber layers comprise different fiber orientations or similar fiber orientations.

In other embodiments, the roof assembly can include a reinforcing member positioned between two of the arranged, individual porous cores.

In some configurations, the continuous multi-ply glass fiber skin comprises three, four, five, six, seven, or eight individual glass fiber layers.

In certain embodiments, a fiber orientation in the continuous multi-ply glass fiber skin is arranged to increase side-to-side stiffness of the roof assembly.

In some embodiments, each of the plurality of individual porous cores comprises glass fibers and a polyolefin thermoplastic material.

In certain configurations, the roof assembly can include a radial end-cap coupled to the roof assembly. For example, the radial end-cap can be coupled to a side of one of the porous cores at an edge of the roof assembly. In some embodiments, the side of the porous core abuts the radial end-cap and the continuous multi-ply glass fiber skin overlaps a radius edge of the radial end-cap. In other embodiments, the side of the porous core and a side of the continuous multi-ply glass fiber skin abut the radial end-cap.

In certain embodiments, a basis weight of each of the individual glass fiber layers is from 50 g/m² to 1000 g/m² . In other embodiments, a fiber orientation in at least one of the individual glass fiber layers is in a same direction as a direction where strength of the roof assembly is selected.

In some configurations, the roof assembly can include an insulation layer coupled to the plurality of individual porous cores. In certain embodiments, an additional porous core coupled to the insulation layer. In other embodiments, the insulation layer comprises one or more of a polystyrene foam or an expandable polystyrene foam.

In certain embodiments, the roof assembly can include a support member coupled to the insulation layer. For example, the support member can include wood, aluminum or steel.

In another aspect, a roof comprises a plurality of roof support members, wherein each of the plurality of roof members comprises an exterior facing surface and an interior facing surface, and wherein the plurality of roof support members are spaced to form a roof sub-structure. In certain embodiments, a multi-layer assembly can be coupled to the roof sub-structure, wherein the multi-layer assembly comprises a plurality of individual porous cores each coupled to a continuous multi-ply glass fiber skin. In some embodiments, each of the porous cores is coupled to the exterior facing surfaces of the plurality of roof support members to position the continuous multi-ply glass fiber skin toward an external environment of the roof. In other embodiments, each of the plurality of the porous cores comprises a web comprising a random arrangement of reinforcing materials held in place by a thermoplastic material. In some embodiments, the continuous multi-ply glass fiber skin comprises at least two individual glass fiber layers each comprising a unidirectional orientation of glass fibers held in place by a binder material.

In certain embodiments, the roof comprises a radial end-cap coupled to an end of the multi-layer assembly and to at least one of the plurality of roof support members.

In some embodiments, the roof comprises an adhesive layer between the individual porous cores and the continuous multi-ply glass fiber skin. For example, the adhesive layer comprises one or more of polyurethane, a polyolefin or a polyamide.

In certain configurations, at least two individual glass fiber layers comprises different fiber orientations or same fiber orientations.

In certain embodiments, the roof comprises a reinforcing member positioned between two of the arranged, individual porous cores.

In other embodiments, the continuous multi-ply glass fiber skin comprises three, four, five, six, seven, or eight individual glass fiber layers.

In certain embodiments, fiber orientation in the continuous multi-ply glass fiber skin is arranged to increase side-to-side stiffness of the roof.

In other embodiments, each of the plurality of individual porous cores comprises glass fibers and a polyolefin thermoplastic material.

In some configurations, the roof comprises a radial end-cap coupled to at least one of the roof support members. In certain embodiments, the radial end-cap is coupled to a side of one of the porous cores at an edge of the roof sub-structure. In some embodiments, the side of the porous core abuts the radial end-cap and the continuous multi-ply glass fiber skin overlaps an edge of the radial end-cap. In other embodiments, the side of the porous core and a side of the continuous multi-ply glass fiber skin abut the radial end-cap.

In certain embodiments, a basis weight of each of the individual glass fiber layers is from 50 g/m² to 1000 g/m² . In some examples, a fiber orientation in at least one of the individual glass fiber layers is in a same direction as a direction where cross-directional strength of the roof is selected.

In some embodiments, the roof comprises an insulation layer coupled to the plurality of individual porous cores. In other embodiments, the roof comprises an additional porous core coupled to the insulation layer. In some embodiments, the insulation layer comprises one or more of a polystyrene foam or an expandable polystyrene foam.

In certain embodiments, the roof support members comprise wood framing members. In other embodiments, the roof comprises a radial end-cap coupled at least one of the wood framing members, wherein the radial end-cap comprises a step to receive some portion of one of the porous cores and provide a flat surface between a radius edge of the radial end-cap and the received portion of the porous core, and wherein the continuous multi-ply glass fiber skin is bonded to at least some portion of the radius edge of the radial end-cap.

In another aspect, a radial end-cap configured to couple to a roof rafter and couple to a continuous fiber skin of a multi-layer assembly is described. For example, the end-cap can include a body comprising a radius edge and a coupling edge. The radius edge can be configured to couple to the continuous fiber skin. The coupling edge comprises at least one interface configured to receive the roof rafter.

In certain embodiments, the body comprises a step at the coupling edge. In other embodiments, a height of the step is configured to mirror a height of the plurality of individual porous cores. In some embodiments, the body comprises two interfaces each configured to couple to a respective roof rafter. In additional embodiments, the radius edge comprises two separate arc surfaces.

In certain embodiments, the body of the radial end-cap comprises a front plate and a back plate, wherein each of the front plate and the back plate comprises a respective radius edge and wherein the interface couples the front plate to the back plate.

In some embodiments, the interface is orthogonal to a longitudinal plane of each of the front plate and the back plate and retains the front plate parallel to the back plate. In other embodiments, a height from the interface to the radius edge of each of the front plate and the back plate mirrors a dimension of the roof rafter received by the radial end-cap. In some embodiments, the body of the radial end-cap is an integral body comprising a polymer. In certain embodiments, an arc length of the radius edge is 4 cm to 30 cm.

In another aspect, a recreational vehicle comprises a frame comprising wheels, a floor coupled to the frame, a plurality of walls coupled to the floor and a roof coupled to the plurality of walls to form an interior space within the recreational vehicle, and wherein the roof comprises the roof assembly described herein. A radial end-cap can be present in the roof assembly of the recreational vehicle if desired.

In an additional aspect, a modular home comprising the roof assembly or roof described herein is described. For example, the modular home can include a floor, a plurality of walls coupled to the floor, and a roof coupled to the plurality of walls to form an interior space within the modular home. A radial end-cap can be present in the roof assembly of the modular home if desired.

Other structures including a building structure, e.g., shed, home, etc., other types of vehicles, e.g., a truck, automotive vehicle, delivery van, etc., can also include the roof assemblies, roofs and multi-layer assemblies described herein.

Additional aspects, examples, embodiments and features are described in more detail below.

### BRIEF DESCRIPTION OF THE SEVERAL VIEWS OF THE DRAWINGS

Certain aspects, features, elements, configurations and components are described with reference to the accompanying drawings in which:

FIG. 1 is an exploded view of certain components that can be present in a multi-layer assembly;

FIG. 2 is an illustration showing a side-view of the components of FIG. 1 assembled into a multi-layer assembly;

FIG. 3 is an illustration showing the components of FIG. 1 assembled into a multi-layer assembly with an adhesive layer between the porous cores and the continuous skin;

FIG. 4 is an illustration showing the components of FIG. 1 assembled into a multi-layer assembly with an adhesive layer between the two porous cores;

FIG. 5 is an illustration showing the components of FIG. 1 assembled into a multi-layer assembly with an adhesive layer between the two porous cores and an adhesive layer between the porous core and the continuous skin;

FIG. 6 is an illustration showing a skin positioned between two porous cores and a continuous skin;

FIG. 7 is an illustration showing three cores stacked adjacent to each other;

FIG. 8 is an illustration showing four cores stacked adjacent to each other;

FIG. 9 is an illustration showing five cores stacked adjacent to each other;

FIG. 10 is an illustration showing six cores stacked adjacent to each other;

FIG. 11 is an illustration showing seven cores stacked adjacent to each other;

FIG. 12 is an illustration showing eight cores stacked adjacent to each other;

FIG. 13 is an illustration showing cores stacked top-to-bottom;

FIG. 14 is an illustration of a continuous skin comprising zero degree fibers;

FIG. 15 is an illustration of a continuous skin comprising ninety degree fibers;

FIG. 16 is an illustration of a continuous skin comprising forty-five degree fibers;

FIG. 17 is another illustration of a continuous skin comprising forty-five degree fibers;

FIG. 18 is an illustration showing a 2-ply continuous skin including a 0/90 fiber arrangement;

FIG. 19 is an illustration showing a 2-ply continuous skin including a 90/0 fiber arrangement;

FIG. 20 is an illustration showing a 2-ply continuous skin including a 0/0 fiber arrangement;

FIG. 21 is an illustration showing a 2-ply continuous skin including a 90/90 fiber arrangement;

FIG. 22 is an illustration showing a 2-ply continuous skin including a 0/0 fiber arrangement where one of the plys has more fibers per unit area;

FIG. 23 is an illustration showing a 2-ply continuous skin including a 0/90 fiber arrangement where one of the plys has more fibers per unit area;

FIG. 24 is an illustration of a three cores on top of a continuous skin;

FIG. 25 is an illustration showing flaps present in a continuous skin;

FIG. 26 is another illustration showing flaps present in a continuous skin;

FIG. 27 is a perspective view of a radial end-cap;

FIG. 28 is another perspective view of a radial end-cap;

FIG. 29 is another perspective view of a radial end-cap;

FIG. 30 is an illustration showing a multi-layer assembly coupled to a radial end-cap. ;

FIG. 31 is an illustration showing a skin layer coupled to porous cores;

FIG. 32 is an illustration showing a foam layer coupled to porous cores;

FIG. 33 is an illustration showing a foam layer coupled to porous cores and additional porous cores coupled to the foam layer;

FIG. 34 is an illustration of a recreational vehicle;

FIG. 35 is an illustration of a utility trailer;

FIG. 36 is an illustration of a shuttle van;

FIG. 37 is an illustration of a delivery vehicle;

FIG. 38 is an illustration of a temporary shelter;

FIG. 39 is an illustration of a shed;

FIG. 40 is an illustration of a modular home;

FIG. 41 is an illustration showing a continuous skin with different fiber densities at different areas of the skin;

FIG. 42 is another illustration showing a continuous skin with different fiber densities at different areas of the skin;

FIG. 43 is an illustration showing a roof assembly coupled to a wall;

FIG. 44 is an photograph showing a multi-layer assembly used as a roof;

FIG. 45 is an illustration showing a radial end-cap configured to couple to two different support members at different angles;

FIG. 46 is a photograph showing an assembled recreational vehicle roof;

FIG. 47 is an illustration showing reinforcing members; and

FIG. 48 is an illustration showing an anti-slip material on a surface of a continuous fiber skin.

It will be recognized by the person of ordinary skill in the art, given the benefit of this disclosure, that the figures are not drawn to scale and that certain dimensions may have been enlarged, reduced or otherwise distorted to facilitate a more user-friendly description. The exact thickness of the layers, skins and other materials described in connection with the illustrative embodiments herein have been intentionally distorted to provide a better view of the various elements that can be present in any one configuration of a multi-layer assembly. Unless specified in connection with a particular embodiment or feature, any particular size, thickness or orientation is not intended.

### DETAILED DESCRIPTION

Certain embodiments are described below to illustrate better some of the novel and inventive features that can be present in the multi-layer assemblies described herein. Not necessarily all features are present in all embodiments, and various features can be interchanged or substituted with other features to provide a desired multi-layer assembly for an intended use. Various fiber arrangements are shown in the figures merely for illustration purposes and to provide contrast between the different components in the roofs and roof assemblies described herein. Specific fiber arrangements are also specified herein in connection with certain assemblies that can impart selected features or arrangements.

In certain embodiments, the multi-layer assemblies described herein are typically used in applications where impact resistance and weather resistance is desired. For example, the multi-layer assemblies can be designed to support a specific load across a span of a roof and at the same time provide weather resistance, e.g., be water-resistant, watertight or waterproof. The outer layer of the multi-layer assembly is typically a continuous fiber skin which is non-porous and made of materials which do not support mold or bacterial growth. The inner layer(s) of the multi-layer assembly typically provide some structural support and can also provide some insulation and/or acoustic properties to mitigate thermal transfer and/or transfer of noise, harmonics or vibrations through the multi-layer assembly. The multi-layer assemblies can be used with various underlying support structures including cellulose based and non-cellulose based support structures, e.g., wood rafter, aluminum rafters or beams, steel rafters or beams, etc. In comparison to existing roofs, for example, which often leak due to poor adhesion between flimsy PVC or TPO membranes and underlying OSB substrate, the multi-layer assemblies described herein can be bonded to an underlying support structure with high adhesion and a reduced likelihood of separation.

In certain configurations, multi-layer assemblies are described that include two or more porous cores coupled to a single or multi-ply continuous skin layer. Referring to FIG. 1, a first porous core 100 and a second porous core 101 are shown as being separate from a continuous skin 110. The porous cores 100, 101 need not span an edge-to-edge distance of the skin 110 and, as noted below, the skin 110 can be longer and/or wider than the porous cores 100, 101 to facilitate attachment to an underlying support structure. The exact fiber arrangement in the skin 110 can be selected to impart structural strength to the assembly and permit the assembly to be used in roofs in vehicles and structures including, for example, recreational vehicles, cabins, modular homes, sheds, stationary caravans, trucks or other vehicles and structures.

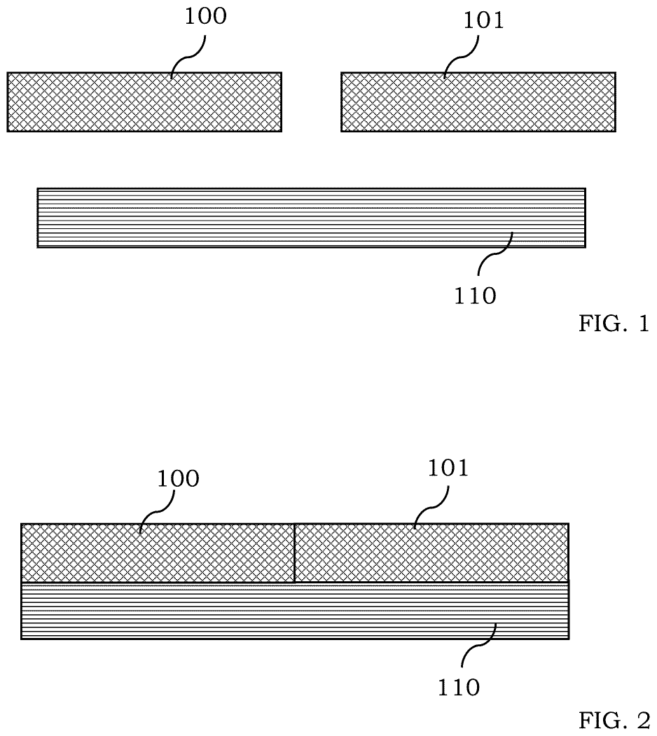

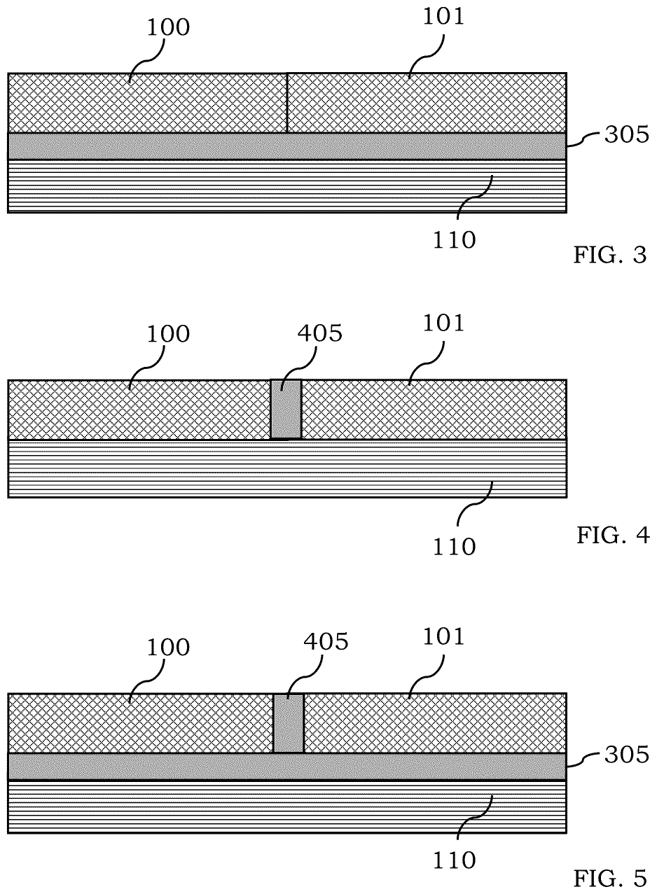

In some instances, the porous cores 100, 101 can be coupled to the skin 110 at a first surface of the skin 110 without using any adhesive or other layer between them as shown in FIG. 2. If desired, however, an adhesive layer 305 (see FIG. 3) can be present between the porous cores 100, 101 and the skin 110. Various types of materials which can be used as an adhesive layer are discussed below. In other configurations, an adhesive layer 405 can be present between the two porous cores 100, 101 as shown in FIG. 4. In other arrangements, both the adhesive layer 305 and the adhesive layer 405 can be present as shown in FIG. 5. The dimensions of the adhesive layers 305, 405 have been intentionally enlarged for illustration purposes.

In certain embodiments, a skin layer 605 can be present between the porous cores 101, 101 and the continuous skin 110. The skin layer 605 can function as an adhesive but typically has some structure so the skin 605 can be applied as a separate material layer onto a surface of the continuous skin 110 and/or the porous cores 100, 101. For example, the skin 605 can be a film, scrim, frim, or other layers that can act to couple the porous cores 100, 101 to the continuous skin 110.

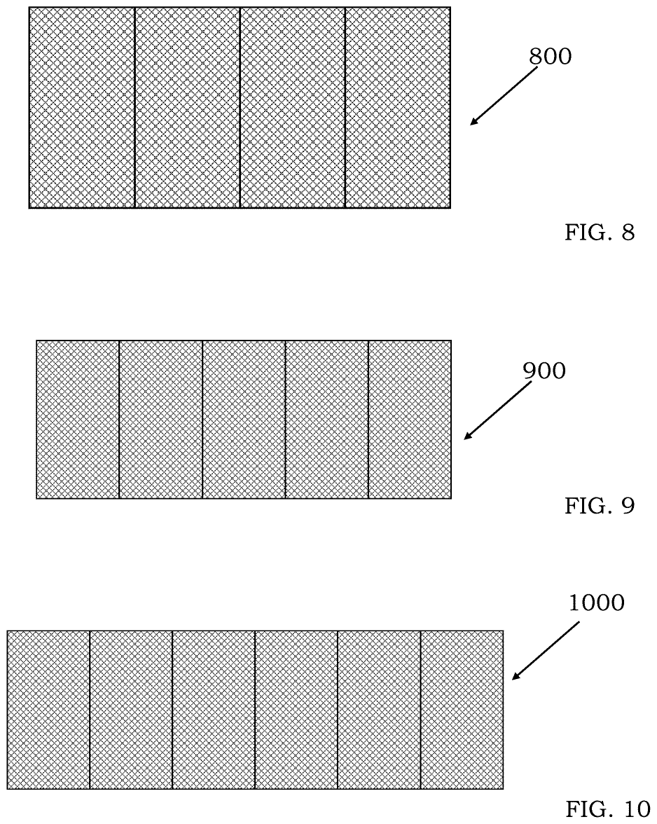

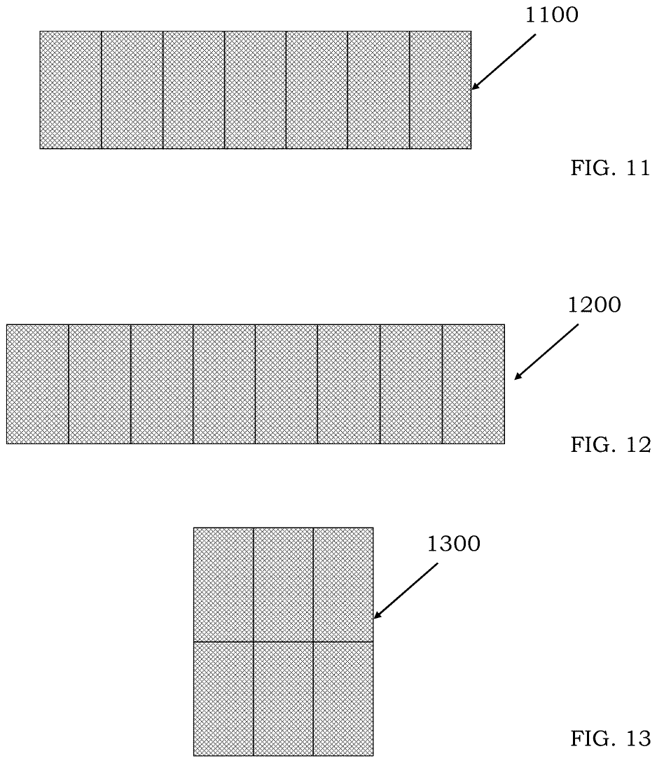

In certain configurations, the exact number of porous cores used in the multi-layer assemblies described herein can vary from two up to twenty depending on the overall size of the roof. Typical assemblies used in recreational vehicle roofs include three porous cores 700 (FIG. 7), four porous cores 800 (FIG. 8), five porous cores 900 (FIG. 9), six porous cores 1000 (FIG. 10), seven porous cores 1100 (FIG. 11) or eight porous cores 1200 (FIG. 12) coupled to a first surface of a continuous skin as shown in the top view of FIGS. 7-12 where the continuous skin is positioned below the porous cores and cannot be seen. The cores can be abutted to each other at the edges or can overlap to some degree if desired. The cores can be the same or can be different. For example, one or more of the cores can include a higher fiber loading if that core is placed at an area of a roof where more mechanical strength is desired. The exact dimension of each core can be the same or can be different and in some instances each core is about 48 inches wide by 96 inches long. For wider assemblies, different cores can be positioned “top-to-bottom” as shown in the assembly 1300 of FIG. 13. Further, porous cores can be cut to size and/or shapes according to the dimensions and/or shape of the support structure to be used with the multi-layer assembly. The exact number of cores present in any one assembly can vary and can be selected, for example, based on the overall length of the assembly. In general, enough cores can be used so they span an entire length of a roof or roof assembly that includes the multi-layer assembly described herein.

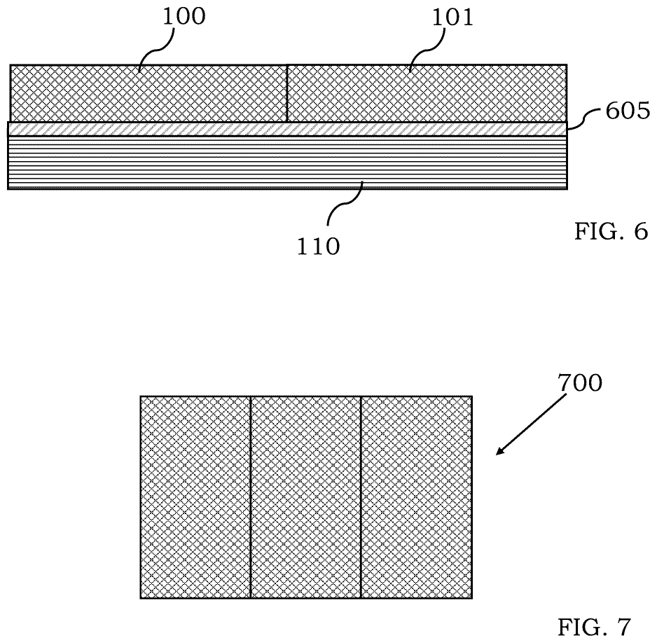

In a typical arrangement of the assemblies shown in FIGS. 1-13, the assembly is positioned so the continuous skin 110 is on an external surface of the particular vehicle or structure and the porous cores underly the continuous skin 110 and are closer to the structural support members of the vehicle or structure. The continuous skin 110 can function as a weatherproof barrier and can be watertight or waterproof so water cannot penetrate into the multi-layer assembly. By orienting the assembly with the skin 110 toward the external environment, the combined skin 110 and underlying porous cores can provide a structural roof which can couple to underlying beams, trusses, supports, etc. and which has desired mechanical properties.

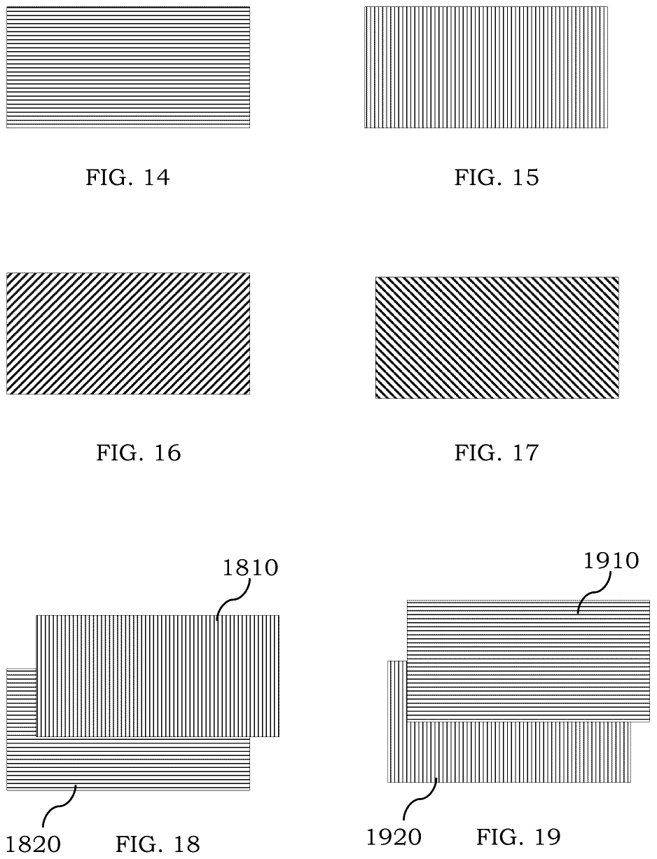

In certain embodiments, the continuous skin 110 can include oriented fibers and a binder. The oriented fibers are generally oriented at the same angle in each layer or ply of the continuous skin 110, though the fiber orientations in different layers can be the same or can be different. The continuous skin 110 typically includes at least two, three, four, five, six, seven, eight or more individual layers or plys. Referring to FIGS. 14-18, various fiber orientations in single layers are shown and include zero degree fibers (FIG. 14), ninety degree fibers (FIG. 15), or forty-five degree fibers (FIG. 16 and FIG. 17). Other fiber angles between 0 -90 degrees are also possible, e.g., thirty degree fibers and sixty degree fibers can be used. The zero degree fiber orientation can be referenced based on the longitudinal axis of the skin 110 so the fiber orientation is parallel to the direction of the longitudinal axis. The fibers in each layer are generally parallel to each other. In some examples, a continuous skin can be produced by coupling a film to a fiber-based scrim so the resulting 2-ply material includes both fibers and a binder material. The film typically does not include any fibers though it can if desired.

In some instances, the skin 110 can include at least two layers having a 0/90 fiber arrangement (bottom layer 1820 with 0 degree fibers and a top layer 1810 with 90 degree fibers) as shown in FIG. 18 with the fiber layers being shifted to show each layer and with the zero degree fiber layer being positioned closer to the porous cores. In another embodiment, the skin 110 can include at least two layers having a 90/0 fiber arrangement (bottom layer 1920 with 90 degree fibers and a top layer 1910 with 0 degree fibers) as shown in FIG. 19 with the fiber layers being shifted to show each layer and with the ninety degree fiber layer being positioned closer to the porous cores.

In certain embodiments, the skin 110 can include multiple layers or plys having the same fiber arrangement. For example, a 0/0 arrangement is shown in the layers 2010, 2020 in FIG. 20. A 90/90 arrangement is shown in the layers 2110, 2120 in FIG. 21. In some instances, even though similar fiber arrangements can be present in different layers of a skin, the fiber spacing in different layers or plys can be different. Referring to FIG. 22, the bottom ply 2220 can include a narrow fiber spacing and have more fibers per unit area than the number of fibers in the top ply 2210. If desired, a top ply 2310 could include more fibers per unit area than the number of fibers in a bottom ply 2320 even where the fiber orientations are different in different layers. If desired, an adhesive material/layer can be present between different plys of the skin or the binder material in each ply can be used to bond the different plys to each other to form the skin 110.

In certain configurations, the exact number of layers or plys in the skin 110 can vary from two to twenty, more particularly three to twelve or four to eight plys. The fibers and/or binder present in the different plys can be the same or can be different. In some embodiments, the fibers in the skin 110 are inorganic fibers, whereas in other configurations the fibers 110 are organic fibers. If desired, a layer or ply of the skin 110 can include both inorganic and organic fibers. Examples of inorganic fibers include, but are not limited to, glass fibers, carbon fibers, ceramic fibers, metal fibers or combinations thereof. Examples of organic fibers include, but are not limited to, polyamide fibers, aromatic polyamide fibers, bicomponent fibers including shell/core arrangement or side-by-side arrangements of fibers where at least one of the fibers is an organic fiber, polymeric fibers and combinations thereof. In certain embodiments, each of the fibers present in each layer of the skin 110 can include glass fibers or aromatic polyamide fibers. Where glass fibers are present, the glass fibers can be twisted or untwisted as desired.

In certain configurations, the skin 110 can include a binder material which typically is an organic material that can act to retain the fibers in their desired orientation. In some embodiments, the binder material comprises a polyolefin, a polyurethane, a polyamide, a copolyamide, a polyethylene terephthalate or combinations thereof. In certain embodiments, the binder material can include a mixture of a polyolefin and a polyurethane or a mixture of two different polyolefins or two different polyurethanes. For example, the binder material can include a mixture of polypropylene and polyethylene. In some embodiments, the skin 110 can also include UV inhibitors, antioxidants, elastomers or other materials which can facilitate use of the skin 110 in a roof or roof assembly.

In certain embodiments, the exact thickness and/or basis weight of the continuous skin 110 can vary depending on the desired mechanical properties of the skin 110. For example, the skin 110 can have a thickness of about 0.5 mm to about 10 mm, more particularly about 1 mm to about 5 mm or about 2 mm to about 4 mm. The skin 110 can be produced by arranging fibers and then applying a binder to the arranged fibers to retain the fiber arrangement. Fibers can be pulled from fiber bundles and placed in a desired orientation prior to application of any binder. Sizing agents or other materials can be applied to the fibers as desired.

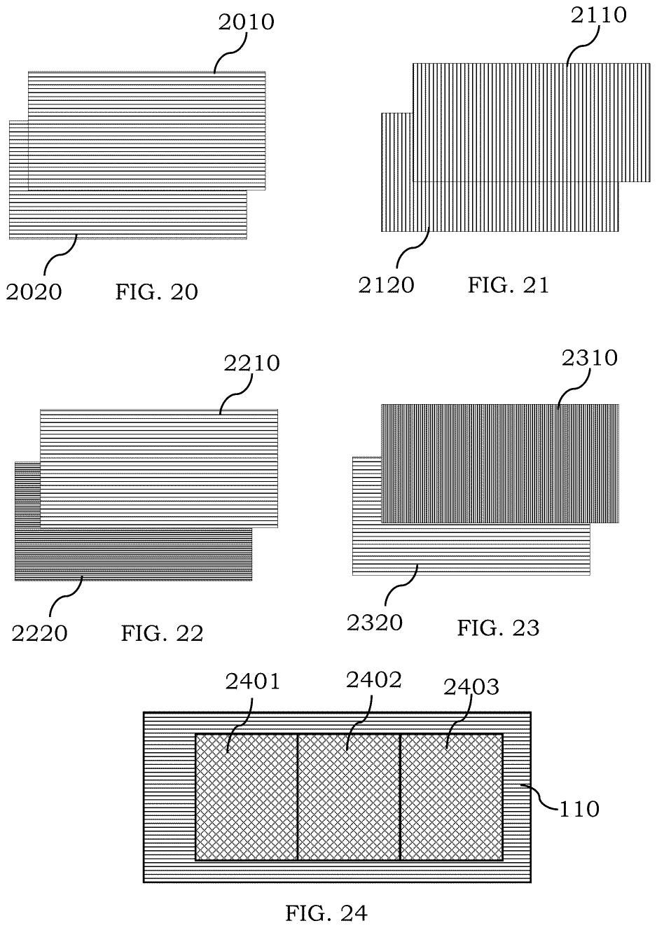

In certain embodiments, the overall dimensions of the skin 110 can be the same as or different than the combined dimensions of the placed cores. The skin 110 is typically cut to size so it overlies the arranged cores and/or any other layers present in the multi-layer assembly. The skin 110 can be pulled from a roll of material or may be used in sheet form. In some arrangements, the skin 110 can have larger dimensions than the placed cores to permit the edges of the skin 110 to overlap top edges of an underlying support structure. An illustration is shown in FIG. 24 where a skin 110 has a larger length and/or width than the cores 2401, 2402, 2403 placed on a first surface of the skin 110. The enhanced length of the skin 110 provides for “flaps” which can be drawn over an edge of a support structure to create a continuous overlying layer. For example, an edge where a roof meets a wall is often a joint which experiences water ingress in vehicle applications and in building applications. By sizing the skin 110 larger than the roof itself, the edges of the skin can be pulled over the joint formed by the roof support structure/wall assembly to provide a continuous covering at this area.

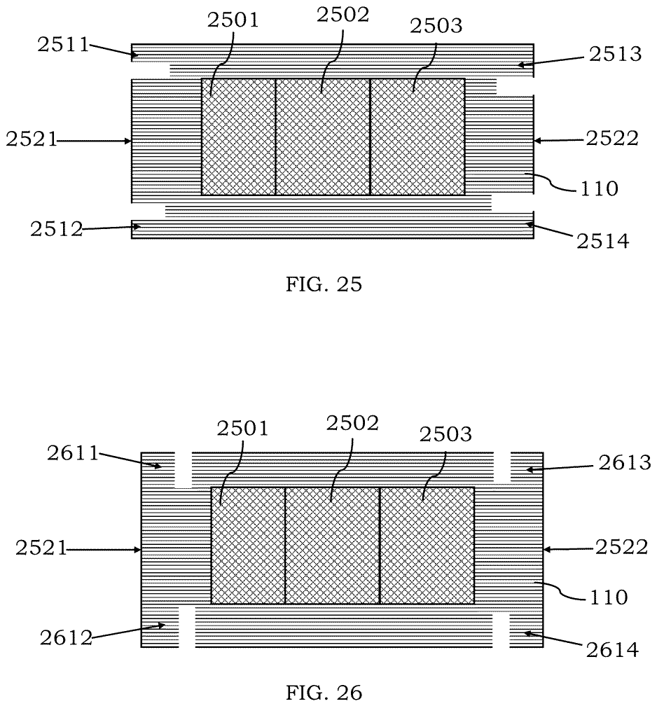

In certain configurations, the skin 110 can include relief cuts or other cuts which can permit the skin to be wrapped onto itself during assembly of the final structure including the multi-layer assembly. Referring to FIG. 25, an assembly is shown which includes a skin 110 and placed cores 2501, 2502, and 2503 on a first surface of the skin 110. Flaps 2511, 2512, 2513 and 2514 in the skin 110 are present and can be used to wrap the skin material over the lateral edges 2521, 2522 of the skin 110 when the assembly is installed. The open space adjacent to the flaps 2511, 2512, 2513 and 2514 can provide some strain relief as the skin 110 is rigid or semi-rigid. The flaps 2511, 2512, 2513 and 2514 can be placed on top of the lateral edges 2521, 2522 so there is no opening at the edges of the assembly. For example, the lateral edges 2521, 2522, can be placed over a joint formed at an edge of a roof support/wall assembly. The flaps can then be wrapped over the lateral edges 2521, 2522 of the skin 110 so there is no open space at the joint of the roof support structure/wall assembly interface. The exact flap orientation, size, angles, etc. can depend on the particular orientation and/or size of the support structures. For example, flaps 2611, 2612, 2613 and 2614 can be present in a skin as shown in FIG. 26 if desired.

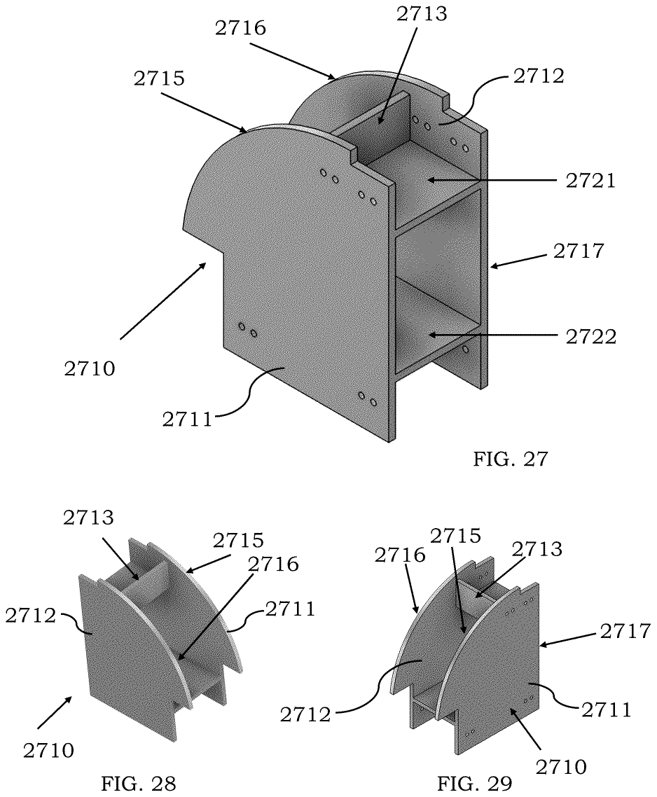

In some embodiments, the multi-layer assemblies described herein can be used with a radial end-cap 2710 as shown, for example, in FIG. 27. Depending on the type of fibers and fiber loading present in the skin 110 and/or the cores, the assembly can be rigid and may be difficult to wrap over edges formed by an interface of a roof support structure/wall assembly. Strain can be also be introduced by pulling the skin 110 over ninety degree edges. The radial end-cap can be coupled to a roof support structure so a more gentle/gradual angle is formed at the edges of the roof. For example, a body of radial end-cap can include an arc surface, e.g., a radius edge, so the change in direction of the skin 110 placed over the radial end cap (see FIG. 28) is less abrupt. The radial end-cap 2710 can maintain a consistent radius edge using edges 2715, 2716 (see FIGS. 28 and 29) to reduce strain and enhance bonding of the skin 110 to the cap 2710. The radius edges 2715, 2716 are shown in FIG. 27 as having two separate arc surfaces, but the body of the radial end-cap 2710 could include a continuous arc surface across a width of the body if desired. The radial end-cap 2710 can also increase bonding between the porous cores and the skin 110 as bond strength stresses can be reduced. The radial end-cap 2710 can include a coupling edge 2717 comprising at least one interface, e.g., interfaces 2721, 2722, designed to contact/couple to the roof support structure at edges of the roof support structure. The body of the end-cap 2710 can be formed from a front plate 2711 and a back plate 2712. Each of the front plate 2711 and the back plate 2712 can include a respective radius edge 2715, 2716. An interface, e.g., 2721 or 2722 or both, can couple the front plate 2711 to the back plate 2712 and can hold the radial end-cap 2710 together. An optional stop 2713 is shown which can be present to position the rafter or support member (not shown) an appropriate distance within the interface 2721. As noted in more detail below, the front plate 2711, the back plate 2712 or both can include a cut or step sized to receive a core and provide a generally flat horizontal surface across a transition area between the radial end-cap 2710 and the core. In other instances, the cut or step can be sized so the porous core and the continuous skin abut the end-cap 2710 at the step and so every ply of the continuous skin does not overlap the radius edge of the end-cap 2710. For example, certain plys of the continuous skin may abut against the end-cap 2710 and other plys can overlap the radius edge of the end-cap 2710. If desired, no plys of the continuous skin can overlap the radius edge of the end-cap. The radial end-cap 2710 can be assembled on site using the various components of the radial end-cap 2710 or can be produced as a unitary body, e.g., through molding, printing or forming operations.

In one configuration, the interface 2721 can be orthogonal to a longitudinal plane of each of the front plate 2711 and the back plate 2712 and act to hold the front plate 2711 and back plate 2712 parallel to each other. The horizontal interface can also act to hold any coupled roof support structures flat. A width of an opening formed by the front plate 2711 and the back plate 2712 can be selected so a framing member fits tightly into the opening. For example, where a 1″×2″ board is used, which has actual dimensions of 0.75″×1.5″, the opening between the two plates 2711, 2712 can be about 0.75 inches or about 1.5 inches depending on the desired orientation of the framing member. Where a 2″×4″ board is used, which has actual dimensions of 1.5″×3.5″), the opening between the two plates 2711, 2712 can be about 1.5 inches or 3.5 inches depending on the desired orientation of the framing member. Similarly, a height above an interface can mirror the dimensions of the framing member that is intended to couple to the radial end-cap.

In certain embodiments, the exact dimensions of the radial end-cap 2710 can vary depending on the particular roof support structure dimensions, the desired arc length of the radial end-cap, etc. In general, the interfaces 2721, 2722 are sized with an appropriate width so an individual support member, e.g., a roof rafter, can be inserted into each of the interfaces 2721, 2722 through a friction fit or semi-friction fit. The stop 2713 when present can facilitate a proper insertion depth of the support structure. While the exact size of the support member can vary, the support member often is a 1″×2″, 1″×3″, 2×3, 2″×4″, 2″×6″, 2″×8″, 2″×10″ or 2″×12″ wood board that is typically used in framing applications to frame a roof and/or wall. The inserted support member can be stapled, nailed, screwed or glued to the radial end-cap to hold the radial end-cap to the support member. The dimensions of the radial end-cap can vary, and in some instances a radius of the end-cap may be 4 cm to about 50 cm or 5 cm to about 40 cm or 10 cm to about 30 cm. Where a central angle of the arc is ninety degrees (as shown in FIG. 27), the arc length can be about 3 cm to about 80 cm, more particularly about 3 cm to about 40 cm or about 4 cm to about 30 cm or about 5 cm to about 20 cm.

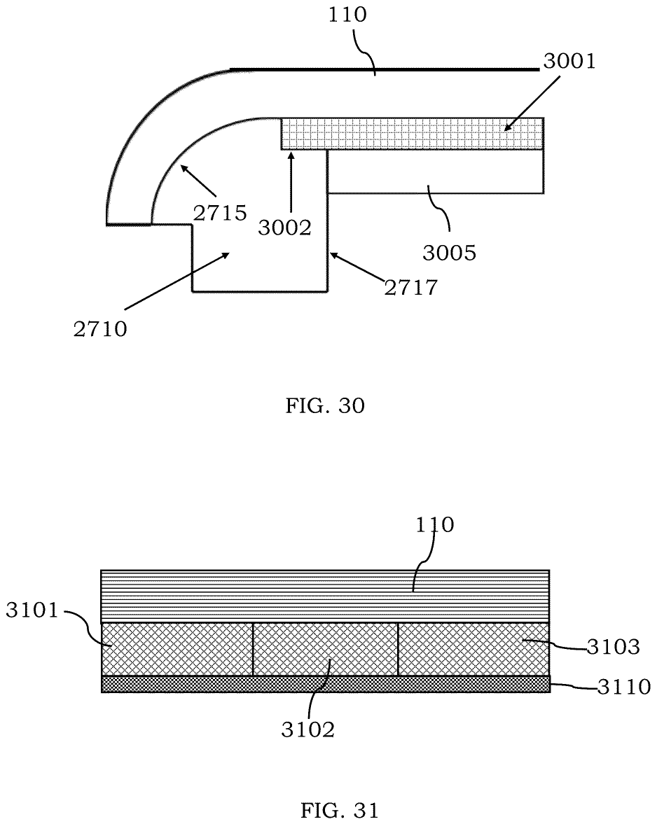

In certain configurations, a multi-layer assembly can be installed to form a roof and coupled to the radial end-cap 2710 as shown in FIG. 30. A roof support structure 3005, e.g., a roof rafter or a joist, can be inserted and attached to the radial end-cap 2710 through an end-cap interface. A multi-layer assembly including a porous core 3001 and a skin 110 can then be placed on top of the radial end-cap and support member 3005 so the skin 110 overlaps at least some of arc surface of the radius edge 2715 of the radial end-cap 2710. The radial end-cap 2710 can include a cut or step 3002 at an upper area of the coupling edge 2717 to receive a portion of the porous core 3001. If desired, the height of the step 3002 can be selected to match the thickness of the porous core 3001 so a generally horizontal flat surface is created across the transition from the radial end-cap 2710 to the core 3001. Overlap of the core 3001 onto the end-cap 2710 can also provide some structural reinforcement to the edge of the roof. While the skin 110 is shown as completely overlapping the entire arc length of the radial end-cap 2710 in FIG. 30, this arrangement is not required and the skin 110 may terminate at some portion along the arc of the radial end-cap 2710 as desired. The roof support structure could be angled and couple to the radial end-cap assembly so a slanted roof, arched roof or vaulted roof is formed as noted in more detail below. In such configurations, an interface of the radial end-cap can include a corresponding angle so the interface and the roof support member couple to each other at an appropriate angle or pitch. Typical roof pitches include 0/12 (flat roof) to 12/12 or 1/12 to 11/12 or 2/12 to 9/12 or 4/12 to 8/12, though the exact pitch selected can depend on snow load or other weight bearing or mechanical considerations. In other instances, the roof can be arched or vaulted and have some curvature to enhance water run off.

In certain embodiments, a plurality of individual radial end-caps can be used where a single radial end-cap is coupled to a single roof support structure. The radial end-caps can be sized so they abut each other and leave little or no space between adjacent radial end-caps. In an alternative configuration, a single radial end-cap sized to have a length that mirrors a roof length can be used. The single radial end-cap can include interfaces at a desired spacing, e.g., 12 inches, 16 inches, 20 inches, 24 inches, etc., to couple the radial end-cap to roof support structure. Nails, screws, adhesives or other materials can couple the interface to the support structure.

In another configurations, radial end-caps can be produced so they can be cut to size for a particular roof length. For example, a radial end-cap assembly can include ten, sixteen, twenty or more end-caps in a unitary assembly. A user can cut the end-cap assembly to size so a respective number of interfaces are present to couple to the number of roof supports that are present.

In an additional configuration, individual radial end-caps can plug or couple to each other, e.g., through friction or interference fit, to form a chain of radial end-caps, e.g., radial end-caps can engage each other in an end-to-end manner to facilitate their use. The coupling mechanisms used to fit different radial end-caps to each other can be tongue and groove, stud and tube, projection and slot, bayonets, bendable ears, snap fittings or other devices which can temporarily hold the different radial end-caps to each other. Upon final assembly, each radial end-cap can couple to a roof support structure through nails, screws, adhesives or other means.

In certain configurations, the radial end-cap can be produced using polymeric materials which can be the same or different than the polymeric materials used in the porous cores and/or the continuous skin. For example, the radial end-cap can include a polyolefin, a polyurethane, a polycarbonate, a polystyrene, a polyamide, a polyetherimide, a polyphenylsulfone, or other polymeric materials. In certain embodiments, the radial end-cap can include polypropylene, high density polyethylene, nylon, acrylonitrile butadiene styrene, polyoxymethylene, polymethyl methacrylate, polyether ether ketone, polybutylene terephthalate, polyethylene terephthalate or combinations thereof. If desired, the materials can also include a UV inhibitor, anti-oxidants, elastomers or other materials to alter the overall properties of the radial end-cap. In some embodiments, the radial end-cap can include materials similar to an adhesive material used to bond the continuous skin to the radial end-cap so there is material compatibility. If desired, a coefficient of thermal expansion of the radial end-cap can be matched, or be close to, a coefficient of thermal expansion of the continuous skin so material mismatch does not result in the continuous skin from becoming unbonded to the radial end-cap.

In certain embodiments, the porous cores described herein are generally produced as planar sheets or articles that comprise a web of open cell structures formed by reinforcing materials held together with a thermoplastic material. For example, a porous core can be formed from a random arrangement of reinforcing materials, e.g., reinforcing fibers, that are held in place by the thermoplastic material, e.g., a thermoplastic resin material. The reinforcing materials may be reinforcing fibers, whiskers or other materials that can impart some reinforcement to the LWRT composite articles. The porous core typically comprises a substantial amount of open cell structure such that void space is present in the core. In some instances, the porous core may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. The overall thickness of the core can vary depending on the desired weight and/or use environment, e.g., may vary from about 0.5 mm to about 12 mm as desired.

In certain embodiments, the thermoplastic material used to form the porous cores described herein may include one or more of a polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the porous core can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the core can vary and illustrative amounts range from 20% by weight or more, e.g., 20 % to 80% by weight or 35% to 80% by weight or 45% to 75% by weight or 45% to 70% by weight or 50% to 65% by weight based on the weight of the porous core. It will be recognized by the skilled person that the weight percentages of all materials used in the porous core will add to 100 weight percent. The thermoplastic material can include virgin materials, recycled or reproduced materials or both. For example, the thermoplastic material can include recycled thermoplastic material to increase the sustainability of the LWRT composite articles including the porous core. In some instances, a combination of virgin and recycled thermoplastic material together can be present in the porous core. For example, virgin polyolefin (e.g., polypropylene, polyethylene, etc.) can be used in combination with recycled polyolefin (e.g., polypropylene, polyethylene, etc.).

In certain embodiments, the reinforcing materials of the cores described herein may comprise glass fibers, carbon fibers, graphite fibers, synthetic organic fibers, particularly high modulus organic fibers such as, for example, para-and meta-aramid fibers, nylon fibers, polyester fibers, a high melt flow index resin fiber (e.g., 100 g/10 min. melt flow index or above), mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In other embodiments, the cores can include reproduced polymeric fibers, bi-component fibers, e.g., sheath-core fibers, or fibers produced from recycled materials. In some embodiments, any of the aforementioned fibers can be chemically treated prior to use to provide desired functional groups or to impart other physical properties to the fibers, e.g., may be chemically treated so that they can react with the thermoplastic material, the lofting agent or both. The fiber content in the cores may independently be from about 20% to about 80% by weight of the core, more particularly from about 30% to about 70%, by weight of the core or 30% by weight to 60% by weight of the core or 35% by weight to 60% by weight of the core. The particular size and/or orientation of the fibers used may depend, at least in part, on the thermoplastic material used and/or the desired properties of the core. In one non-limiting illustration, fibers dispersed within a thermoplastic material and optionally other additives to provide the cores can generally have a diameter of greater than about 5 microns, more particularly from about 5 microns to about 22 microns, and a length from about 5 mm to about 200 mm, more particularly, the fiber diameter may be from about 2 microns to about 22 microns and the fiber length may be from about 5 mm to about 75 mm.

In certain arrangements, reinforcing fibers in the core are typically randomly oriented, though if desired, the fibers in the core could be oriented in suitable directions, e.g., at 0 degrees, 15 degrees, 30 degrees, 45 degrees, 60 degrees, 75 degrees or 90 degrees, relative to a machine direction used to produce the cores or relative to a direction of a longitudinal axis of the core. Different fibers may also be present with different orientations in a porous core.

In other embodiments, other additives may also be present in the core comprising the thermoplastic resin and the reinforcing materials. For example, a lofting agent, flame retardants, colorants, smoke suppressants, surfactants, foams or other materials may be present in the core. If desired, recycled materials, biomaterials, bioparticles, ground natural material or other sustainable materials can be included in the cores. In some examples, the core may substantially halogen free or halogen free core to meet the restrictions on hazardous substances requirements for certain applications. In other instances, the core may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the core), more particularly about 1 weight percent to about 13 weight percent, e.g., about 5 weight percent to about 13 weight percent based on the weight of the core. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the core. If desired, two different substantially halogen free flame retardants may be added to one or more of the cores described herein. In certain instances, one or more of the cores described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the core. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

In certain embodiments, the exact basis weight of the porous core may vary depending on the materials present and thickness. As noted herein, the porous cores are typically thin, e.g., less than 12 mm thick or less than 15 mm thick, to reduce overall weight. In some instances, a basis weight of each porous core may vary from about 100 grams/m² (gsm) to 3500 gsm, more particularly about 500 gsm to about 2500 gsm or about 750 gsm to 2250 gsm or 1000 gsm to 2200 gsm or even 1250 gsm to 2000 gsm.

In certain examples, one or more of the cores described herein can be generally prepared using chopped fibers (reinforcing fibers or reproduced polymeric fibers or both), a thermoplastic material (virgin, recycled or both), optionally a lofting agent and/or other materials. For example, a thermoplastic material (virgin, recycled or both) and any fibers can be added or metered into a dispersing foam contained in an open top mixing tank fitted with an impeller. If desired, separate tanks can be used for virgin thermoplastic materials and recycled thermoplastic materials to permit adjustment of the exact amounts of each material in the final article. Without wishing to be bound by any particular theory, the presence of trapped pockets of air of the foam can assist in dispersing the fibers and the thermoplastic material. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web comprising the fibers and the thermoplastic material. The wet web can be passed through a dryer at a suitable temperature to reduce moisture content and to melt or soften the thermoplastic material. The skin layers, foam layers, etc. can then be applied to the web optionally using an adhesive material between the web and the other layers. The assembly can be passed through one or more sets of rollers to press the skins into the web and/or compress the assembly to a desired thickness. The resulting thermoplastic composite article can be cut, sized or otherwise subjected to post-production steps as desired. The machine direction of the process generally refers to the direction of the moving wire screen, whereas the cross direction refers to a direction orthogonal to the machine direction. As noted herein, if desired, the reinforcing fibers can be randomly oriented or oriented at a specific angle with respect to the machine direction. It may be desirable to orient fibers in the core to have an angle of orientation of 30 degrees, 45 degrees, 60 degrees, 75 degrees or 90 degrees relative to the machine direction or relative to a direction of a longitudinal axis of the core.

In certain configurations, the porous cores described herein can be produced by adding a plurality of reinforcing materials and a thermoplastic material (virgin, recycled or both) to an agitated aqueous foam to form a dispersed mixture. The dispersed mixture of the plurality of reinforcing materials, the reproduced polymeric fibers and the thermoplastic material can be deposited onto a forming support element, e.g., a moving wire screen or other element. Liquid but not the reinforcing materials or thermoplastic material can be evacuated from the deposited, dispersed mixture to form a web. The web, for example, may comprise the reinforcing materials which are held in place by the thermoplastic material. The web can be heated above a softening temperature of the thermoplastic material. This softening temperature can vary depending on the nature of the different thermoplastic materials that may be present. The heated web can be compressed to a selected or predetermined thickness, e.g., 12 mm or less or 10 mm or less or 8 mm or less or 6 mm or less or 4 mm or less. A skin layer, foam layer, etc. can be disposed on the compressed web to provide the thermoplastic composite article. Alternatively, a skin layer can be disposed on the web prior to compression and the resulting thermoplastic composite article can be compressed to a desired overall thickness. The resulting assembly is typically used with a continuous skin to form a final assembly that can be used in forming a roof or other structures.

In certain embodiments, the multi-layer assembly can include a continuous skin 110, a plurality of individual porous cores 3101, 3102, 3103 and a skin layer 3110 as shown in FIG. 31. The skin layer 3110 may comprise a single layer of material or multiple layers of different materials as desired. In some embodiments, the skin layer 3110 may comprise, for example, a film (e.g., thermoplastic film or elastomeric film), a frim, a scrim (e.g., fiber based scrim), a foil, a woven fabric, a non-woven fabric, a flame retardant polymer or be present as an inorganic coating, an organic coating, or a thermoset coating disposed on the cores 3101, 3102, 3103. In some examples, the skin layer 3110 may comprise natural fibers, polymeric fibers, reproduced polymeric fibers, biomaterials as described herein or other materials. In other instances, the skin layer 3110 may comprise a limiting oxygen index greater than about 22, as measured per ISO 4589 dated 1996. Where a thermoplastic film is present as (or as part of) the skin layer 3110, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. The film can include virgin materials, recycled materials or both. Where a fiber based scrim is present as (or as part of) the skin layer 3110, the fiber based scrim may comprise at least one of glass fibers, aramid fibers, graphite fibers, carbon fibers, inorganic mineral fibers, metal fibers, metalized synthetic fibers, and metalized inorganic fibers. The fiber based scrim can include virgin materials, recycled materials or both. Where a thermoset coating is present as (or as part of) the skin layer 3110, the coating may comprise at least one of unsaturated polyurethanes, vinyl esters, phenolics and epoxies. The thermoset coating can include virgin materials, recycled materials or both. Where an inorganic coating is present as (or as part of) the skin layer 3110, the inorganic coating may comprise minerals containing cations selected from Ca, Mg, Ba, Si, Zn, Ti and Al or may comprise at least one of gypsum, calcium carbonate and mortar. The inorganic coating can include virgin materials, recycled materials or both. Where a non-woven fabric is present as (or as part of) the skin layer 3110, the non-woven fabric may comprise a thermoplastic material, a thermal setting binder, inorganic fibers, metal fibers, metallized inorganic fibers and metallized synthetic fibers. The non-woven fabric can include virgin materials, recycled materials or both. In some configurations, the skin layer 3110 may comprise recycled or reproduced polymeric fibers that are also present in the core. Where the skin layer 3110 comprises recycled or reproduced polymeric fibers, the reproduced polymeric fibers in the skin layer 3110 can include one or more of recycled or reproduced polyethylene terephthalate fibers, recycled or reproduced polyethylene fibers, recycled or reproduced polypropylene fibers, reproduced polyamide fibers, recycled or reproduced nylon fibers, recycled or reproduced co-polyamide fibers, reproduced high density polyethylene fibers, and combinations thereof. In some configurations, the fibers may comprise recycled or reproduced glass fibers, e.g., glass fibers which have been recycled and/or reclaimed with optional physical and/or chemical treatment prior to reuse. The exact amount of fibers in the skin layer 3110 may vary from about 5% by weight to about 90% by weight, more particularly about 5% by weight to about 80% by weight, e.g., about 5-20% by weight, 5-30% by weight, 5-40% by weight, 5-50% by weight, 5-60% by weight, 10-60% by weight, 10-50% by weight, 20-50% by weight, 20-40% by weight or about 20 weight percent to about 80 weight percent or other amounts. The skin layer 3110 may also be fiber free if desired. If desired, the skin layer 3110 can include liquid crystals which can be oriented in a desired manner to provide a desired optical effect.

In some embodiments, an adhesive layer may optionally be present between the continuous skin 110 and the cores. In instances where an adhesive is desirable, one or more thermoplastic polymer adhesives, polyurethane adhesives, siliconized polyurethane adhesives or other adhesives commonly used in the RV industry to bond layers to each other may be used. For example, it may be desirable to couple the continuous skin 110 to each of the cores using an adhesive layer. In some examples, the thermoplastic component of the adhesive layer may comprise a thermoplastic polymer such as, for example, a polyamide, a co-polyamide or a polyolefin such as a polyethylene or a polypropylene. The thermoplastic component of the adhesive layer can include recycled or virgin thermoplastic materials if desired. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof. The adhesive is typically sprayed on, rolled, on or otherwise applied to surfaces of the continuous skin 110 and/or cores to bond them to each other. Such bonding may occur to provide a pre-formed assembly including the continuous skin and cores, or individual cores can be provided separately from the continuous skin and used along with an adhesive material at the point of assembly.

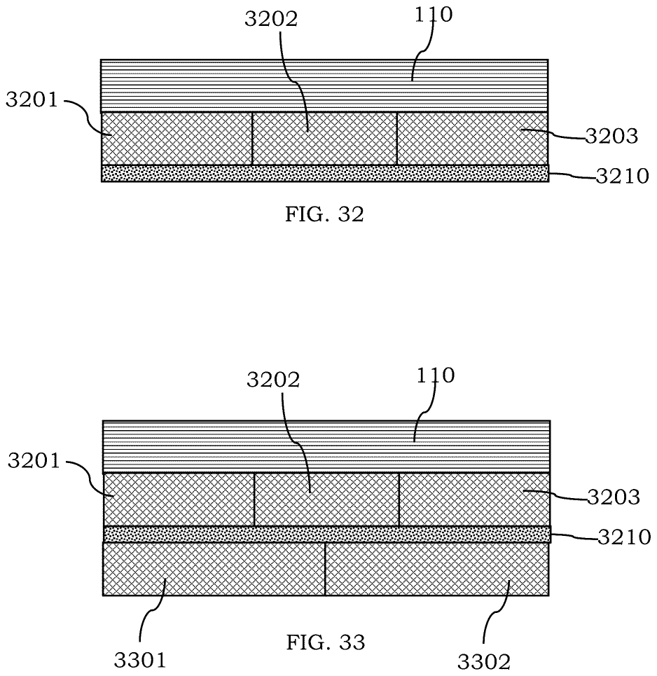

In certain configurations, the multi-layer assemblies described herein can include other layers coupled to the porous cores. For example and as shown in FIG. 32, a multi-layer assembly can include a continuous skin 110, a plurality of porous cores 3201, 3202, 3203, 3204, and a foam layer 3210. The foam layer 3210 can act as an insulation layers and/or assist in absorbing impacts. In some embodiments, the foam layer 3210 can include one or more of polystyrene, extruded polystyrene, expanded polystyrene, graphite polystyrene, polyisocyanurate, or other materials. The foam layer 3210 can be closed cell or can be open cell depending on what other materials are placed adjacent to the multi-layer assembly. In a typical arrangement where the multi-layer assembly is used in a roof, the foam layer 3210 would be a closed cell material. If desired, the multi-layer assembly can also include additional porous cores 3301, 3302 as shown in FIG. 33. The number of cores at different areas of the multi-layer assembly can be the same or can be different. Where multiple, separated cores are present, it can be desirable to offset the seams, e.g., the sides where the cores abut, of the cores as shown in FIG. 33. The exact thickness of the foam layer can vary from about 1 mm to about 10 mm as desired. Further, a foam layer can be sprayed or blow into a cavity formed by the multi-layer assembly to seal any openings if desired.

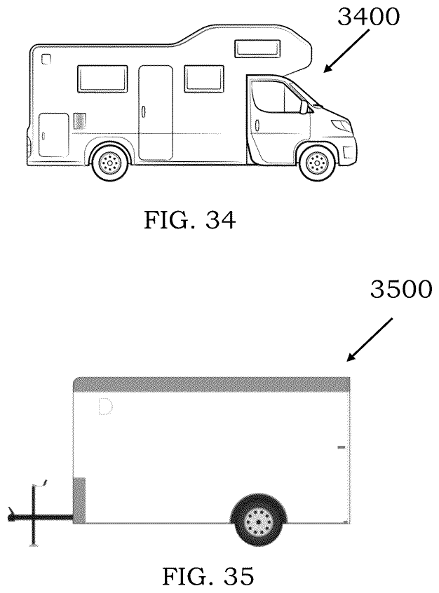

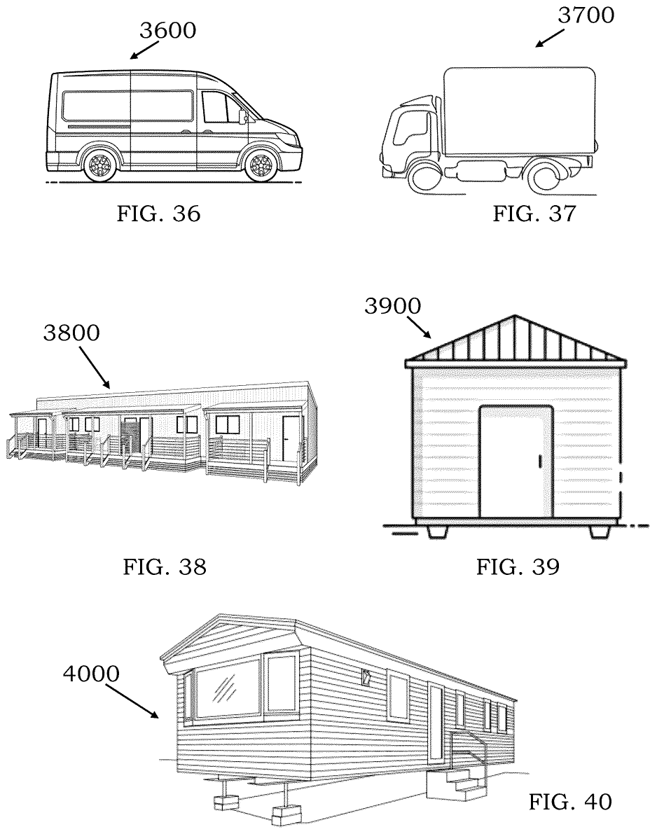

The multi-layer assemblies described herein can be used in roofs of a recreational vehicles 3400 (FIG. 34), a utility trailer (3500 FIG. 35), a shuttle van 3600 (FIG. 36), a delivery vehicle 3700 (FIG. 37), a temporary shelter 3800 (FIG. 38), a shed 3900 (FIG. 39), a modular home 4000 (FIG. 40) and the like. The roof can include a radial end-cap or can be attached directly to a side of the vehicle or structure as desired. In some instances, the multi-layer assemblies can be used in various residential and commercial building applications including roofing panels or a continuous roof assembly. Where the roof or roof assembly is present in a recreational vehicle, the recreational vehicle can include wheels, a floor coupled to the frame, a plurality of walls coupled to the floor and a roof coupled to the plurality of walls to form an interior space within the recreational vehicle. A radial end-cap can be present in the roof assembly of the recreational vehicle if desired. Where the roof assembly is used in a modular home, the modular home can include a floor, a plurality of walls coupled to the floor, and a roof coupled to the plurality of walls to form an interior space within the modular home. A radial end-cap can be present in the roof assembly of the modular home if desired.

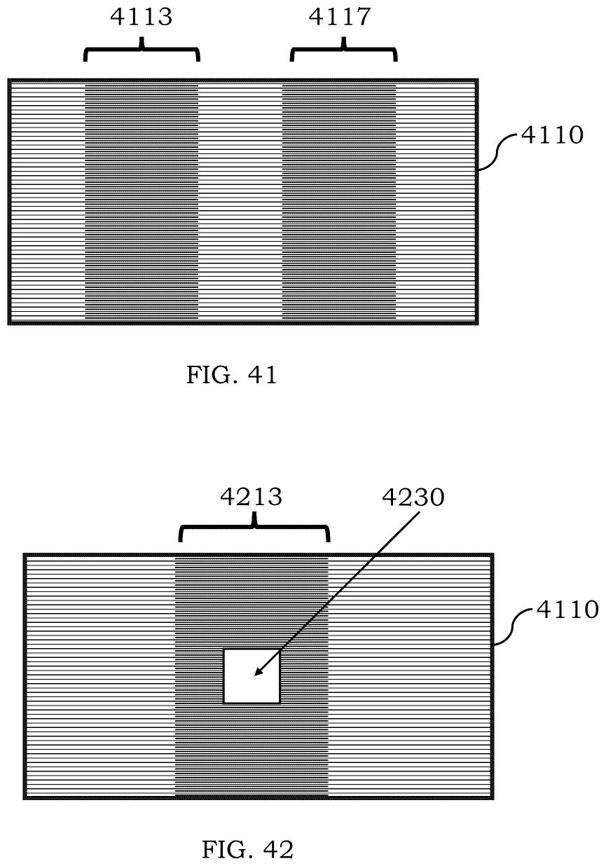

In certain embodiments, it can be desirable to have different fiber densities at different areas of the continuous skin. For example and as shown in FIG. 41, certain areas of a continuous skin 4110 (see areas 4113 and 4117) can have higher fiber densities to impart more strength, e.g., more cross-directional strength or more load bearing capacity, at those areas. Some areas of roofs may need to support larger weights from roof-top air conditioning/heating units, solar cells, radomes or other devices that may provide a continuous load at those areas. Enhanced fiber densities in the continuous skin layer can provide higher weight capacities. In other instances, the fiber density in the continuous skin may be constant across the width and/or length of the continuous skin, and a porous core with higher weight bearing capacity can be placed under areas of the continuous skin where enhanced weight capacity or strength is desired. Further, either configuration can be used at areas where openings are cut into the roof to accommodate skylights, fans or other components designed to penetrate through the roof. An illustration is shown in FIG. 42 where a hole 4230 is surrounded by an area 4213 with increased fiber density to account for termination of the fibers at the hole 4230.

Certain specific examples are described to illustrate some of the novel and inventive features of the technology described herein.

### Example 1

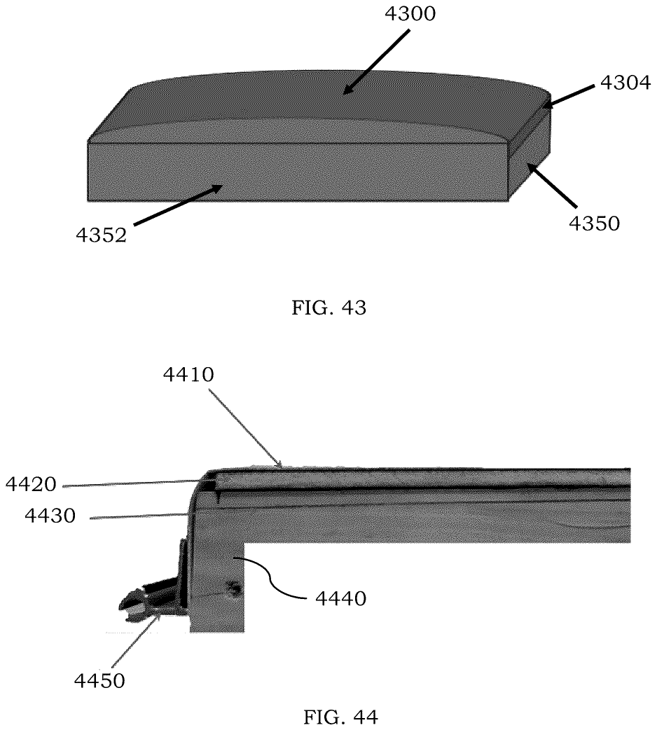

A roof assembly can be produced by placing a multi-layer assembly 4300 on top of roof support structures as shown in FIG. 43. The multi-layer assembly 4300 can be used pre-assembled or assembled on site by bonding porous cores and a continuous skin using an adhesive. An edge 4303 of the multi-layer assembly can be positioned over a top edge of a wall 4350 so the roof is continuous from side to side of the roof support structures. The exact orientation of the fibers can vary and in one arrangement, at least one of the plys in the continuous skin of the assembly 4300 comprises fibers which run from the front wall 4352 to a back wall (not shown) in a direction generally parallel to the wall 4350. The exact number of plys in the continuous skin of the assembly 4300 can vary from two up to about sixteen.

### Example 2

A photograph of a roof/wall assembly showing an overlapping edge that can be formed by the roof is shown in FIG. 44. A continuous skin 4410 is shown overlying a porous core 4420. The porous core 4420 can be attached directly to roof rafters 4430 using an adhesive. In a typical arrangement, enough porous cores are attached to span the entire length of the roof rafters. A continuous skin 4410 can then be placed on top of the adhered porous core 4420 and be bonded to the porous core 4420 using an adhesive. A gutter 4450 can then be attached to a wall 4440 and can receive water run off from the continuous skin 4410, which overlaps the top edge of the wall 4440. In this arrangement, the continuous skin 4410 and porous core 4420 form a multi-layer roof assembly which can be weathertight.

### Example 3

A radial end cap can be placed at edges of a roof and may span an entire width of the roof. For example, a radial end-cap may have a length equivalent to the width of the roof so it spans from roof edge to roof edge. At desired spacing, e.g., 12 inches, 16 inches, 20 inches or 24 inches, an interface may be present to couple the radial end cap to a roof rafter. The roof rafter can be placed into the interfaced and screwed or nailed to the radial end cap at these areas. A multi-layer assembly can then be used to the continuous skin of the multi-layer assembly overlies at least a portion of the outer surface of the radial end-cap. The overlying skin can be bonded to the radial end-cap to retain it in place.

### Example 4

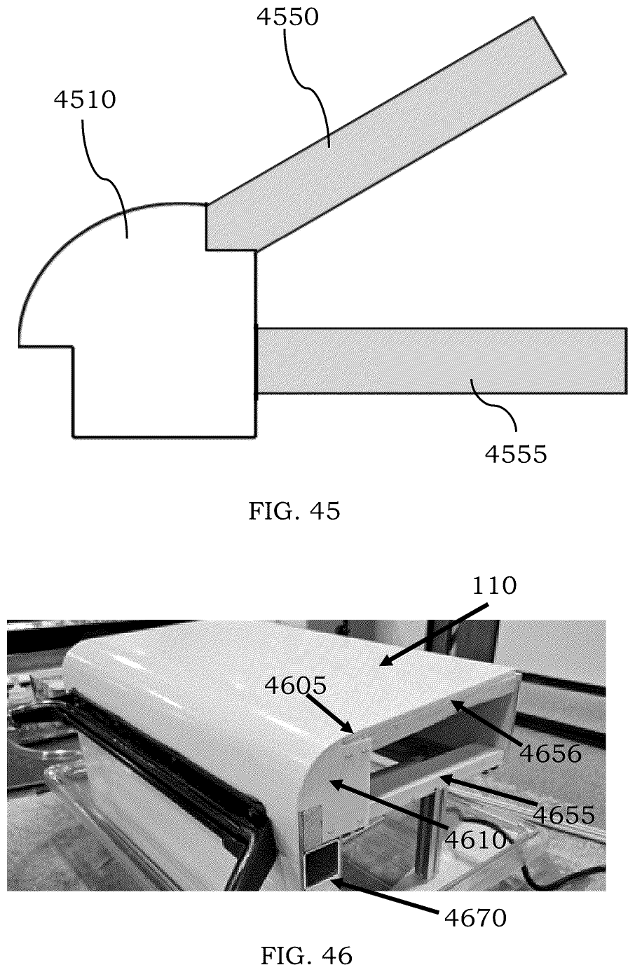

A radial end-cap 4510 that can couple to two roof support members 4550, 4550 is shown in FIG. 45. The support member 4550 can be a roof rafter used to provide a roof pitch, whereas the support member 4555 may be a joist which spans from one side of the roof to the other. The exact angle where the end-cap 4510 interfaces to the rafter 4550 can vary depending on the particular pitch of the roof that is desired. The rafter 4550 can be tied into the joist 4555 within the radial end-cap if desired. A multi-layer assembly (not shown) can be placed on top of the rafter 4550 and the radial end-cap 4510 so the continuous skin of the multi-layer assembly terminated on top of the radial end-cap 4510. In this arrangement, a continuous roof layer is provided. If desired, a bottom surface of the radial end-cap can include perforations or a screen to permit air to flow into the radial end-cap and along an underside of the roof for ventilation purposes.

### Example 5

A photograph is shown in FIG. 46 of a radial end-cap 4610 as present in an assembled roof of a recreational vehicle. The radial end-cap 4610 was coupled to a rafter 4655, a rafter 4656 and a multi-layer assembly including a core 4605 coupled to a continuous skin 110. The radial end-cap 4610 sits on top of tubing 4670 which formed a side-wall of the recreational vehicle. A side of the radial end-cap 4610 was stapled to the rafters 4655, 4656.

### Example 6

An recreational vehicle roof assembly can be produced by assembling a top, continuous glass fiber skin to underlying porous cores. The top, continuous glass fiber-skin can include three or four plys where each ply has a unidirectional orientation of glass fibers. The thickness of the underlying porous cores is typically the same and can vary from 4.5 mm to 10 mm. A radial end-cap can be coupled to horizontal rafters of the framed recreational vehicle roof support structure which are spaces 12″-16″ apart.

### Example 7

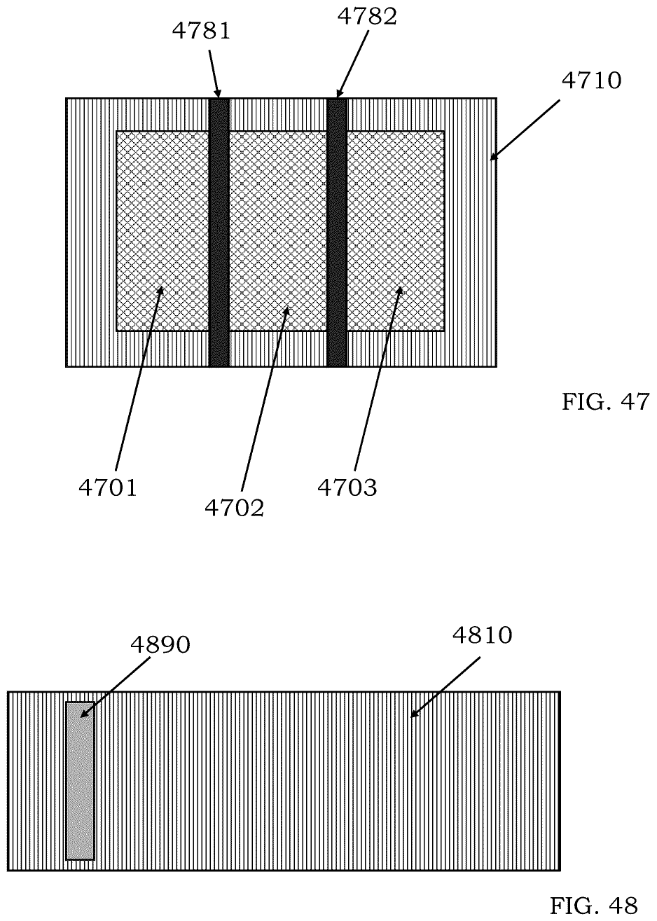

Porous cores 4701, 4702 and 4703 can be positioned on top of a continuous glass fiber skin 4710 as shown in FIG. 47. Reinforcing members 4781, 4782, e.g., stiffeners or ribs, can be positioned between the porous cores 4701, 4702 and 4702 to provide additional support across a width of the multi-layer assembly. The stiffeners can span a width of the skin 4710 (as shown in FIG. 47) or may only span some portion of the length of the cores 4701, 4702, 4703. If desired, the stiffeners 4781, 4782 can be positioned in a direction orthogonal to any underlying support/framing members to enhance load bearing capacity of the assembly.

### Example 8

In instances where the multi-layer assembly is used in roofs that may be walked on, an anti-slip material 4890 can be placed on an exterior surface of a continuous fiber skin 4810 as shown in FIG. 48. The anti-slip material can provide a high friction surface to reduce the likelihood of a user slipping on the continuous fiber skin 4810 as they walk across the surface. Multiple strips of the anti-slip material 4890 can be present if desired.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. A roof assembly comprising:
a multi-layer assembly comprising a plurality of individual porous cores coupled to a continuous multi-ply glass fiber skin at a first surface of the continuous multi-ply glass fiber skin,
wherein each of the plurality of individual porous cores comprises a web comprising a random arrangement of reinforcing materials held in place by a thermoplastic material,
wherein the continuous multi-ply glass fiber skin comprises at least two individual glass fiber layers each comprising a unidirectional orientation of glass fibers held in place by a binder material, and
wherein the plurality of individual porous cores are coupled to the continuous multi-ply glass fiber skin to position the continuous multi-ply glass fiber skin on an exterior surface of the roof assembly.

2. The roof assembly of claim 1, further comprising an adhesive layer between the individual porous cores and the continuous multi-ply glass fiber skin.

3. The roof assembly of claim 2, wherein the adhesive layer comprises one or more of polyurethane, a polyolefin or a polyamide.

4. The roof assembly of claim 1, further comprising an anti-slip material coupled to a second surface of the continuous multi-ply glass fiber skin.

5. The roof assembly of claim 1, wherein the at least two individual glass fiber layers comprises different fiber orientations.

6. The roof assembly of claim 1, further comprising a reinforcing member positioned between two of the arranged, individual porous cores.

7. The roof assembly of claim 1, wherein the continuous multi-ply glass fiber skin comprises three, four, five, six, seven, or eight individual glass fiber layers.

8. The roof assembly of claim 1, wherein a fiber orientation in the continuous multi-ply glass fiber skin is arranged to increase side-to-side stiffness of the roof assembly.

9. The roof assembly of claim 1, wherein each of the plurality of individual porous cores comprises glass fibers and a polyolefin thermoplastic material.

10. The roof assembly of claim 1, further comprising a radial end-cap coupled to the roof assembly.

11. The roof assembly of claim 10, wherein the radial end-cap is coupled to a side of one of the porous cores at an edge of the roof assembly.

12. The roof assembly of claim 11, wherein the side of the porous core abuts the radial end-cap and the continuous multi-ply glass fiber skin overlaps a radius edge of the radial end-cap.

13. The roof assembly of claim 11, wherein the side of the porous core and a side of the continuous multi-ply glass fiber skin abut the radial end-cap.

14. The roof assembly of claim 1, wherein a basis weight of each of the individual glass fiber layers is from 50 g/m² to 1000 g/m².

15. The roof assembly of claim 1, wherein a fiber orientation in at least one of the individual glass fiber layers is in a same direction as a direction where strength of the roof assembly is selected.

16. The roof assembly of claim 1, further comprising an insulation layer coupled to the plurality of individual porous cores.

17. The roof assembly of claim 16, further comprising an additional porous core coupled to the insulation layer.

18. The roof assembly of claim 16, wherein the insulation layer comprises one or more of a polystyrene foam or an expandable polystyrene foam.

19. The roof assembly of claim 16, further comprising a support member coupled to the insulation layer.

20. The roof assembly of claim 19, wherein the support member comprises wood, aluminum or steel.

21-60. (canceled)
